(19) United States
(12) Patent Application Publication
(10) Pub. No.: US 2009/0208282 A1
(43) Pub. Date: Aug. 20, 2009

(54) Connector for Pipe Cleaning Apparatus

(76) Inventor: C. David Hale, Wilmington, OH (US)

Correspondence Address: FROST BROWN TODD, LLC, 2200 PNC CENTER, 201 E. FIFTH STREET, CINCINNATI, OH, 45202, US

(21) Appl. No.: 12/432,128

(22) Filed: Apr. 29, 2009

Related U.S. Application Data
(63) Continuation of application No. 10/170,744, filed on Jun. 13, 2002, now abandoned.

(51) Int. Cl. B25G 3/16; F16B 7/20

(52) U.S. Cl. 403/349

(57) ABSTRACT

The present invention relates to an improved coupling apparatus for tandemly connecting, by hand, separate lengths of a pipe cleaning cable, also referred to as a “snake,” to obtain a cable of extended length suitable for the length of pipe being cleaned.

### PRIORITY

This application is a continuation of U.S. Non-provisional patent application Ser. No. 10/170,744, of the same title filed Jun. 13, 2002 by the present inventor, the disclosure of which is hereby incorporated by reference herein in its entirety.

### BACKGROUND

The present invention generally relates to apparatus typically used for removing sewer pipe clogs and accumulated debris. More particularly the present invention relates to an improved coupling apparatus for tandemly connecting separate lengths of pipe cleaning cables, also referred to as a “snake,” to obtain a cable of extended length suitable for the length of pipe being cleaned.

### PRIOR ART

U.S. Pat. No. 2,880,435 teaches pipe cleaning apparatus, similar to that of the present invention. However, as disclosed and taught in U.S. Pat. No. 2,880,435 an excessive axial force is required to interconnect the cable's end coupling connectors when assembling tandem lengths of cable. Although prior art U.S. Pat. No. 2,880,435 teaches a sloped entry 2 of female coupling 1, (see prior art FIGURE) the “435” patent fails to identify the preferred degree or angle of sloped surface 2. For forty years since the issuance of the “435” patent, industry has chosen a sloped entry surface 2 of forty five degrees. Forty-five degrees is also the apparent slope illustrated in the “435” patent drawings. However, a forty-five degree entry surface 2 has proven to produce a coupling that does not perform in accord with the teaching of the “435” patent. Because of critical structural restraints and requirements placed upon the couplings, the couplings, as taught in the “435”patent, may not be assembled by hand, as represented in the “435” patent, without the use of a hand tool to depress the locking pin of the male coupling during assembly.

### SUMMARY OF THE INVENTION

The present invention presents a coupling, suitable for use in a pipe cleaning operation that may be assembled by use of simple hand pressure thereby eliminating the necessity of using a hand tool to depress the locking pin as required in prior art couplings.

By the present invention the entry chamfered surface of the female coupling is machined at a preferred angle of thirty degrees with the centerline of the coupling whereby simple hand pressure is adequate to connect the couplings without the need for a pin depressing tool as in the prior art.

### BRIEF DESCRIPTION OF THE DRAWINGS

FIG. 1 presents an elevational view, with parts broken away, of a section of cable including end coupling fittings embodying the present invention.

FIG. 2 presents a fragmentary perspective view illustrating two cable coupler sections, embodying the present invention, adapted to interconnect one to the other.

FIG. 3 presents a perspective view disclosing two cable coupler sections, embodying the present invention, connected one to the other.

FIG. 4 is a crossectional view taken along line 4-4 in FIG. 1.

FIG. 5 is a crossectional view taken along line 5-5 in FIG. 1.

FIG. 6 is a crossectional view taken along line 6-6 in FIG. 3.

FIG. 7 presents a free body diagram illustrating the forces acting upon the male coupling's locking pin as the couplings are interconnected.

### DETAILED DESCRIPTION OF THE PREFERRED EMBODIMENT

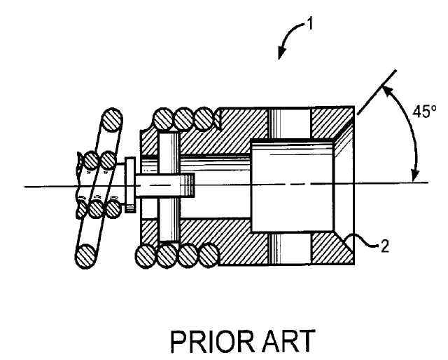

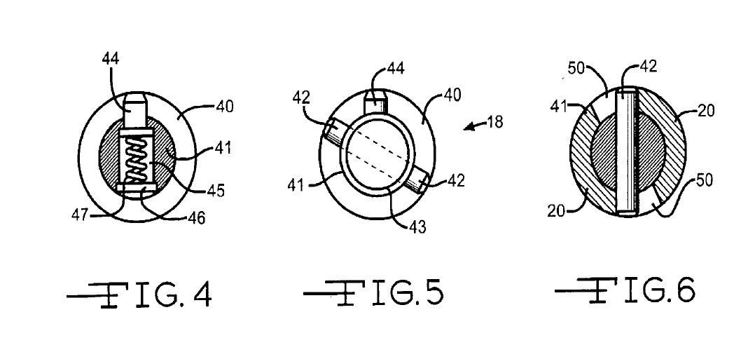

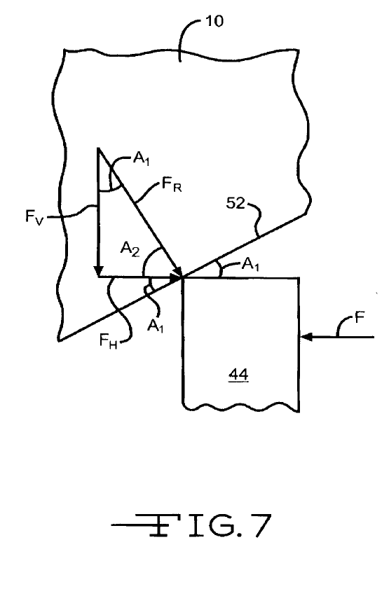

Referring to FIGS. 1 through 6, cleaning cable 10 comprises an elongate inner helical cable 12 and an elongate outer helical member 14. Outer helical cable 14 is rigidly attached at one end thereof to male coupler 18 and at the other end thereof to female coupler 20 by means of threaded engagement with threaded extension 21 provided on coupler 18 and a threaded extension 22 on coupler 20.

The convolutions of the outer helical member 14 which engage the threaded extensions 21 and 22 are in juxtaposed relation by action of the helical threads on extensions 21 and 22 as best illustrated in FIG. 1, while the intermediate convolutions thereof are spaced apart.

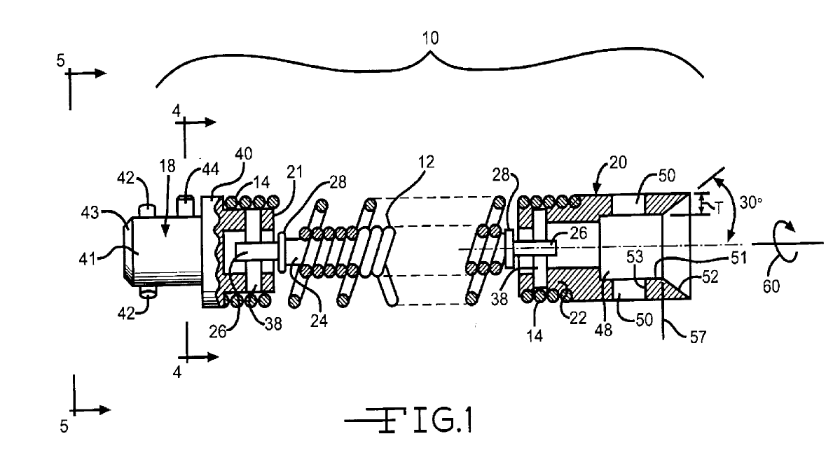

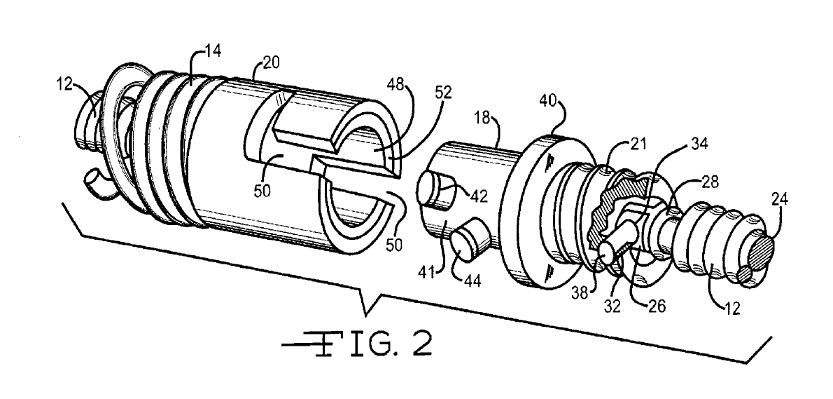

The inner helical member 12 is threadedly attached to a threaded finger, connector or stud 24 provided with a lug or lug head 26. The finger connector 24 is also provided with collar 28 adjacent lug 26. Each of the threaded extensions 21 and 22 of couplers 18 and 20, respectively, is provided with diametrically opposed and aligned apertures 32. Lug 26 is provided with an aperture 34 as shown in FIG. 2. Lug 26 is adapted to be positioned within threaded extension 21 or 22 of cable couplers 18 or 20 such that aperture 34 of lug 26 is in alignment with apertures 32. A pin 38 is positioned in the apertures 32 and through apertures 34 of lug 26, retaining the finger connector 24 to coupler 18 or 20.

FIG. 1 illustrates a section of cleaning cable 10 with attached end couplers 18 and 20. Couplers 18 and 20 may be used to attach a plurality of sections in tandem series relation one to the other to create a total length of cable as may be required during the pipe cleaning process.

Male coupler 18 is provided with flange 40 separating cylindrical portion 41 from threaded extension 21. Adjacent the end of cylindrical portion 41 and extending diametrically therethrough and projecting therefrom is fixed pin 42. The end of the cylindrical portion 41 is provided with tapered portion 43.

Intermediate fixed pin 42 and flange 40 is locking pin 44. Locking pin 44 is disposed in a plane substantially parallel to the plane of pin 42, however, locking pin 44 is angularly disposed, circumferentially, with respect to pin 42 as illustrated in FIG. 2. Locking pin 44 is recessed in cavity 45 that is closed by cover 46, see FIG. 4. Cavity 45 contains spring 47 that biases locking pin 44 outwardly. Experience has shown that a preferred force of approximately eight pounds be applied to locking pin 44, by spring 47, to prevent locking pin 44 from disengaging from slot 50 during reverse rotation (counter clockwise) of cable 10 during removal from the pipe being cleaned. However, an applied force of between six to ten pounds may suffice depending on the particular end use of the clean-out cable.

Coupler 20 is provided with socket 48 adapted to receive cylindrical portion 41 of coupler 18 of another section of cleaning cable. Coupler 20 is provided with diametrically disposed L shaped slots 50 which are adapted to receive the protruding ends of fixed pin 42. The open end of socket 48 includes chamfered portion 52 adapted to engage the spring loaded locking pin 44 and to force locking pin 44 into cavity 45 against the biasing pressure of spring 47 as the cylindrical portion 41 of coupler 18 is fully inserted into socket 48 of coupler 20. As coupling 18 is advanced, pin 44 is forced radially into cavity 45 by interaction with chamfered surface 52.

FIG. 7 presents a free body diagram of the forces acting upon locking pin 44 and chamfered surface 52 as coupler 18 is inserted into coupling 20 during assembly of two cables. As force F is applied to locking pin 44, locking pin 44 is opposed by resisting force FR acting normal to chamfered surface 52 and having a horizontal force component FH equal to force F. Force FR further has a vertical component FV which acts to depress pin 44 into cavity 45. By application of basic rules of trigonometry, the Tangent of angle A1 is the ratio of FH to FV. Therefore, FV is the ratio of FH to the Tangent of angle A1. Thus it is seen that for A1 equaling forty-five degrees FV=FH since the Tan 45=1.00. However, if A1 becomes smaller (less than 45 degrees), the Tangent of A1 becomes progressively smaller thereby affecting a mechanical advantage whereby FV becomes progressively larger as a function of A1 for a given force F. Thus it is possible to increase the effective force FV, acting upon locking pin 44, by reducing angle A1 from forty-five degrees to a smaller angle such as thirty degrees.

Therefore by setting angle A1 at thirty degrees the force F necessary to overcome spring 47 and collapse pin 34 into recess 45 may be significantly decreased whereby coupling 18 may be easily interconnected with coupling 18 by hand operation and without the use of a hand tool to depress pin 44 as the couplings are interconnected. Thus for an angle of A1 equal to thirty degrees, a force F of approximately four and a half pounds is required to depress locking pin 44. Whereas for an angle A1 equal to forty five degrees, as in the prior art, requires a force F of eight pounds to depress locking pin 44. It has been the field experience that applying a force F of eight pounds is not possible by the average maintenance person, whereas applying a force F of four and a half pounds is within the ability of the average maintenance person.

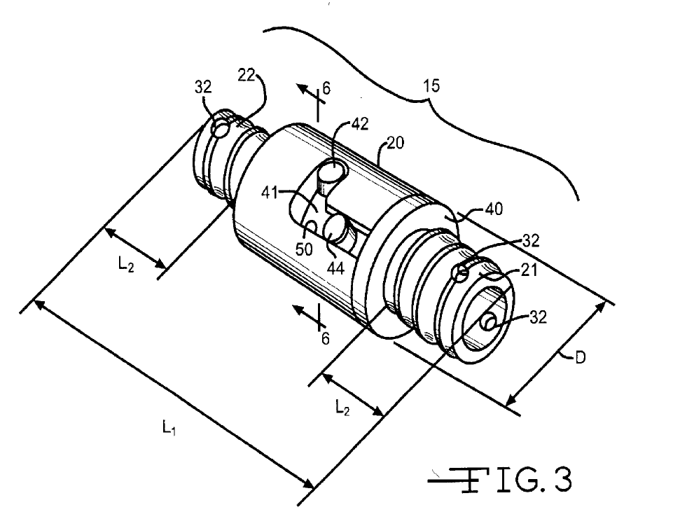

Although thirty degrees is considered to be the preferred angle for chamfered surface 52, it may, depending upon the particular end use of the coupling, possibly range from thirty five to twenty five degrees. However a chamfered surface 52 greater than thirty degrees will obviously result in a greater axial force F being applied to coupling 20 for a given spring 47.

Where cable 10 and the attached connectors 18 and 20 typically negotiate a four inch sewer line having “P” traps therein, it is critical that the overall length L1 (see FIG. 3) of the interconnected couplings be no longer than 2.5 inches and the overall outside diameter D must not exceed 1.375 inches. Otherwise the interconnected coupling 15 will not successively negotiate the four-inch “P” trap. Thus with a required length L2=0.625 inches for extensions 21 and 22 to adequately receive thereon convolutions of outer spring 14, only a length of 1.25 inches remains for the couplings interconnecting and locking elements. Therefore an angle A1 of thirty degrees is considered critical so that sufficient socket wall mass remains, between chamfer 52 and slot wall surface 53, to bear the load applied by locking pin 44 in operational use particularly during withdrawal of the linked cables when only locking pin 44 applies rotational force upon coupling 20.

Because of the torque load applied to the interconnected coupling 15 during pipe clean out it is considered critical that both pins 42 and 44 bare against the complete thickness T of coupling 20, see FIG. 1 during clockwise rotation 60 of cable 10. Therefore it is considered critical that pin 44 bare against the radial thickness T associated with surface 51 of coupling 20, see FIG. 1, and not upon the reduced radial thickness associated with chamfered surface 52. However, if locking pin 44 is too close to slot wall 53, sufficient mass of the coupling wall may be insufficient to withstand the circumferential force applied to the coupling wall by locking pin 44 when cable 10 is rotated counterclockwise during removal of cable 10. Therefore, it is considered critical that locking pin 44 apply its circumferential force, to coupling 20 along line 57 extending radially through the intersection of chamfer 52 and inner wall 51 of coupling 20. Namely, locking pin 44 is in tangential contact with the wall of slot 50 at line 57.

Although the invention has been described in detail with reference to the illustrated embodiment, variations and modifications exist within the scope and spirit of the invention as described and defined in the following claims.

1. A pair of couplers for attachment one to the other comprising:
a) a first coupler having an open ended socket, said socket formed by an axially extending cylindrical wall having an open end and a closed end, said cylindrical wall having at least two diametrically opposed L shaped slots therein, one leg of each of said L shaped slots being open at the open end of said cylindrical wall, said open end of said cylindrical wall having an internal chamfered entry portion, the extended slope of said chamfered portion forming an angle of between twenty five and thirty five degrees with the central axis of said cylindrical wall,
b) a second coupler including a solid portion removably disposed within the socket of said first coupler,
c) a plurality of rigid projections protruding radially from said solid portion of said second coupler, said projections spaced so as to be movable within said L shaped slots in said first coupler's cylindrical wall,
d) a locking pin extending radially from said second coupler, said locking pin depressible within the solid portion thereof,
e) resilient means urging movement of said locking pin in a radial direction from said solid portion of said second coupler as said locking pin moves into and out of said socket,
f) said locking pin being axially and circumferentially spaced from said projections such that as said projections enter said cylindrical wall's L shaped slots said locking pin engages said chamfered portion of said cylindrical wall, said locking pin being depressed by action of the chamfered entry portion of said cylindrical wall as said second coupler is inserted into said first coupler,
g) said locking pin being released into one of said L shaped slots upon full insertion of said second coupling into said first coupling and said second coupling is rotated circumferentially.

2. A pair of cable couplers for attachment one to the other comprising:
a) a first cable coupler including a cylindrical wall forming a socket having a closed end and an open end, said cylindrical wall having a plurality of angularly shaped slots therethrough, each of said slots having a portion thereof parallel to the longitudinal axis of said coupler and a portion angular with respect to the longitudinal axis of said coupler, said open end of said socket having an internal chamfered entry portion, the extended slope of said chamfered entry potion forming an angle of between twenty five and thirty five degrees with the longitudinal axis of said cylindrical socket,
b) a second coupler having a solid cylindrical portion removably positioned within said socket,
c) a plurality of rigid projections radially protruding from the cylindrical portion of said second coupler and so positioned to be movable within both portions of the angularly shaped slots in said first coupler,
d) a locking pin supported by said cylindrical portion and extending radially therefrom,
e) spring means urging radial movement of said locking pin, said locking pin being so positioned with respect to said rigid projections that during insertion of said projections into the slots of said first coupler, said locking pin is depressed by the walls of the socket until the projections pass into the angular portions of said slots,
f) each of said couplers including means for attaching a flexible cable thereto.

3. The couplers as claimed in claim 1 wherein the extended slope of said chamfered entry portion forms an angle of thirty degrees with said longitudinal axis of said cylindrical wall.

4. The couplers as claimed in claim 2 wherein the extended slope of said chamfered entry portion forms an angle of thirty degrees with said longitudinal axis of said cylindrical wall.

5. The couplers as claimed in claim 1 wherein the radial force necessary to overcome said resilient means thereby depressing said locking pin lies within the range of six to ten pounds.

6. The couplers as claimed in claim 5 wherein a radial force of eight pounds is required to overcome said resilient means thereby depressing said locking pin.

7. The couplers as claimed in claim 2 wherein the radial force necessary to overcome said spring means thereby depressing said locking pin lies within the range of six to ten pounds.

8. The couplers as claimed in claim 7 wherein a radial force of eight pounds is required to overcome said spring means thereby depressing said locking pin.
